(19) United States
(12) Patent Application Publication
(10) Pub. No.: US 2025/0020571 A1
(43) Pub. Date: Jan. 16, 2025

(54) Observation Module And Associated Device For Detecting The Presence of At Least One Particle Of An Aerosol

(71) Applicant: Institut de Radioprotection et de Surete Nucleaire, Fontenay-Aux-Roses (FR)

(72) Inventors: Corinne Prevost, Elancourt (FR); Soleiman Bourrous, Saint-Remy-Les-Chevreuse (FR); Christian Hubert, Saint-Maur-des-Fosses (FR)

(73) Assignee: Institut de Radioprotection et de Surete Nucleaire, Fontenay-Aux-Roses (FR)

(21) Appl. No.: 18/707,375

(22) PCT Filed: Nov. 8, 2022
(86) PCT No.: PCT/EP2022/081128

§ 371 Date: May 3, 2024

(30) Foreign Application Priority Data
Nov. 8, 2021 (FR) FR2111821

(51) Int. Cl. G01N 15/1434; G01N 15/14

(52) U.S. Cl. CPC G01N 15/1434; G01N 2015/1486; G01N 2015/1493

(57) ABSTRACT

The invention relates to an observation module for a device for detecting the presence of at least one particle of an aerosol in a stream, the module comprising at least: —A chamber (11) through which flows in service the stream to be analysed, —A light source (12) able to generate a light beam that in service passes through the stream to be analysed, the light source (12) being a square-fibre fibre laser, —An optical cell (14) for collecting a light emission resulting from an excitation of at least the particle of the aerosol by the light source. The invention also relates to a corresponding device.

### CROSS REFERENCE TO RELATED APPLICATIONS

The present application is a national phase entry under U.S.C § 371 of International Application No. PCT/EP2022/081128 filed Nov. 8, 2022, published in French, which claims priority from French Patent Application No. 2111821 filed Nov. 8, 2021, all of which are hereby incorporated herein by reference.

### TECHNICAL FIELD

The invention relates to an observation module for a device for detecting the presence of at least one particle of an aerosol.

The invention also relates to a device for detecting the presence of at least one particle of an aerosol, comprising such a module.

### BACKGROUND OF THE INVENTION

In nuclear environments, in order to protect the operators and to prevent a transfer of radioactive contamination carried by the air to the outside of a building or to the inside of the building, it is known to place air filters in the ventilation network, for example very high-efficiency air filters (better known by the term “high-efficiency particulate air” HEPA filters).

The filters are thus responsible for filtering a large number of particles to ensure that the air breathed by the operators, and potentially in contact with the exterior of the business, is particularly clean.

Under the application of French regulations, the performance of these filters must of course be measured periodically in accordance with standards defining the measurement protocols.

For this purpose, a potential contamination in the ventilation network by a test aerosol (i.e. a tracer aerosol that is not toxic to humans) is simulated, air is sampled before and after passage through one or more filters present in the ventilation network and then, subsequently, a study is performed in the laboratory of the effectiveness of the filters in view of these air samplings.

However, this process proves to be relatively long and restrictive.

### OBJECT OF THE INVENTION

An aim of the invention is to propose an observation module for a device for detecting the presence of at least one particle of an aerosol, which enables the presence of at least one particle of an aerosol to be detected more easily.

An aim of the invention is to propose a device for detecting the presence of at least one particle of an aerosol, comprising such an observation module.

### SUMMARY OF THE INVENTION

In view of the realisation of this aim, an observation module is proposed for a device for detecting the presence of at least one particle of an aerosol in a stream, the module comprising at least:
a chamber through which, in service, the stream to be analysed flows,
a light source able to generate a light beam passing through, in service, the stream to be analysed,
an optical cell comprising at least one optical sensor for collecting a light emission resulting from an excitation of at least the particle of the aerosol by the light source.

In this way, by placing the light source and the optical cell close to a stream to be analysed, the invention can detect, continuously and in real time, the presence of at least one particle of an aerosol in said stream.

More specifically, the particles of the aerosol present in the stream and excited by the light source, will re-emit a light which can then be collected by the optical cell and enables the detection of said particles of the aerosol. For a given aerosol (of known chemical nature), it is therefore sufficient to predefine at least one excitation wavelength for the light source and at least one detection wavelength for the optical cell for detecting particles of said aerosol.

For example, for a nuclear application, it is possible to place the module in a ventilation network (and/or to divert part of the air flowing in the ventilation network in order to send it to the module) downstream and/or upstream of one or more filters of said network: a portion of the air present in the ventilation network then passes continuously through the chamber, which enables the rest of the invention to be able to directly detect, on site, the presence of particles of a test aerosol.

The invention can thus be used directly on site for detecting the presence of at least one particle of an aerosol.

Advantageously, the invention proves to have a simple structure.

The term “aerosol” shall mean a product in the form of particles in suspension in a stream, and in particular a gaseous stream, such as an air stream, for example. An aerosol thus has a chemical nature defined by its various particles.

The term “detection” shall mean the ability of the invention to detect at least one particle of an aerosol (of predefined chemical composition) in a stream.

The term “continuously and in real time” shall mean that it is not necessary to stop the module and to wait for it to be moved to a dedicated place (a laboratory, for example) in order to collect information, the optical sensor being able to supply information directly in place, at the same time as the module continues to operate.

Optionally, the light source is a laser.

Optionally, the laser is a fibre laser.

Optionally, the laser is a square-fibre laser.

Optionally, the module is designed such that, in service, the stream passes through the chamber substantially vertically.

Optionally, the light source is arranged such that the general direction of the light beam extends in a direction which is substantially horizontal.

Optionally, the optical sensor is a camera.

Optionally, the optical sensor is arranged such that its optical axis extends in a direction which is substantially horizontal.

Optionally, the optical sensor and the light source are arranged such that, respectively, an optical axis of the optical sensor and a general direction of the light beam generated by the light source extend substantially orthogonally to one another.

Optionally, the optical sensor is arranged such that an optical axis of the sensor extends, in service, substantially orthogonally to the air stream.

Optionally, the light source is arranged such that a general direction of the light beam generated by the light source extends, in service, substantially orthogonally to the air stream. Optionally, the module comprises at least one optical trap associated with the light source and/or with the optical sensor.

Optionally, the module comprises means for processing information generated by the optical cell.

Optionally, the processing means are configured to characterise the particles of the test aerosol and/or to carry out a simultaneous counting of the particles of the test aerosol.

The term “characterisation” shall mean the ability of the invention to provide a particle size distribution of the particles of the test aerosol present in the stream and/or a concentration of the particles of this aerosol in the stream (the number concentration of particles present in the stream and/or the mass concentration [i.e. the mass of particles present in the air stream]). It is understood that since the invention can detect, continuously and in real time, the presence of at least one particle of an aerosol in said stream, the particle size distribution can be continuously enhanced over time, as well as the values of the mass concentration and number concentration of particles.

The term “simultaneous counting” shall mean the ability of the invention to be able to count, at the same time, a plurality of particles of the aerosol present on a same image acquired by the at least one optical sensor.

The invention also relates to a device for detecting the presence of at least one particle of an aerosol comprising a module such as described above, as well as a preparation module connected to said observation module.

The invention also relates to the application of the module as described above, for monitoring a ventilation network of a nuclear industry site.

The invention also relates to the application of the module as described above, for detecting at least sodium fluorescein.

Other features and advantages of the invention will appear during the reading of the following description of a particular non-limiting embodiment of the invention.

### BRIEF DESCRIPTION OF THE FIGURES

The invention will be better understood in light of the description which follows with reference to the attached figures, among which:

FIG. 1 is a perspective view of a device for detecting the presence of at least one particle of an aerosol according to a particular embodiment of the invention;

FIG. 2 is a sectional view of the device illustrated in FIG. 1;

FIG. 3 is a sectional view of the preparation module of the device illustrated in FIG. 1;

FIG. 4 is a sectional view of the observation module of the device illustrated in FIG. 1;

FIG. 5 is a sectional view from above of the observation module of the device illustrated in FIG. 1.

### DETAILED DESCRIPTION OF THE INVENTION

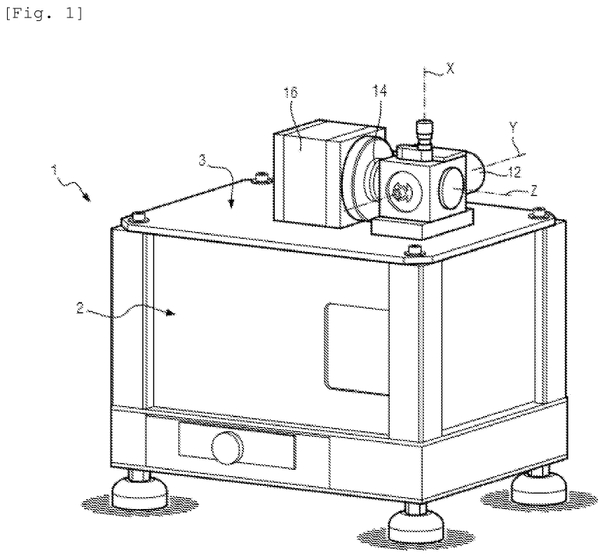

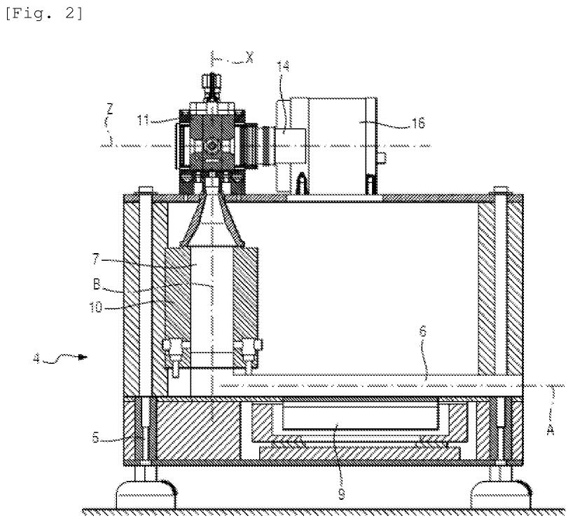

With reference to FIGS. 1 and 2, the device for detecting the presence of at least one particle of an aerosol in a stream according to a particular embodiment of the invention, and generally designated by 1, includes here two main modules, namely a preparation module 2 and an observation module 3 arranged downstream of the preparation module (in the direction of flow of the stream in the device).

In the present case, the stream is a stream of gas and, for example, an air stream.

In the present case, the device 1 is intended to be arranged in a ventilation network of a closed space, such as a nuclear power plant for example, in order to test the efficiency of at least one filter present in this network (for example a HEPA filter).

For this purpose, a protocol for testing the efficiency of at least one filter consists of circulating a test aerosol in the network. The device 1 is situated downstream or upstream of the filter (relative to the direction of flow of the air in the network) in order to be able to detect whether the test aerosol is still present in the air despite its passage through the filter. The device 1 is arrange directly in the ventilation network or even arranged outside of this network, the air flowing in the network being partially diverted from the network in order to be able to then flow through the device 1.

The test aerosol is, for example, sodium fluorescein of formula C₁₀H₂₀O₅Na₂.

Preferably, the observation module 3 is arranged on the preparation module 2, which in turn rests on the ground or a support.

In order to force the flow of the air stream in the device 1, the device is equipped with a pumping assembly (not shown in the figures). The pumping assembly is of course designed to force the circulation of the air stream in the device 1 in order that said air stream flows first in the preparation module 2 and only then in the observation module 3.

The pumping assembly contains, for example, a suction pump connected to the outlet of the observation module 3 (again relative to the direction of flow of the air stream in the device). The pumping assembly preferably also includes a flow regulator associated with said pump in order to be able to control and modulate the flow rate of the air stream passing through the device 1.

The pumping assembly is, for example, arranged above the observation module 3.

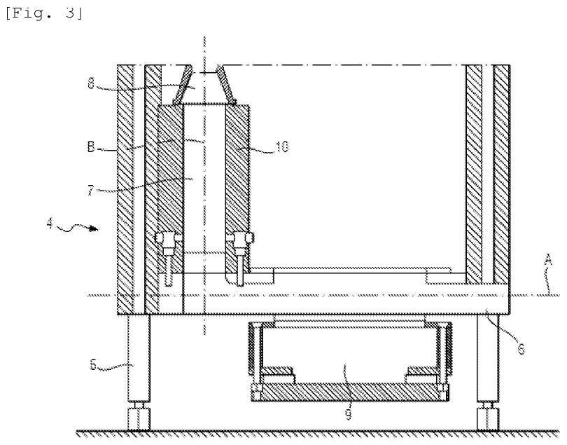

With reference to FIGS. 2 and 3, the preparation module 3 includes a housing 4 resting on the ground via support means 5. Here, the support means 5 comprise four feet.

A flow path of the stream through the preparation module is provided in said module.

Typically, the path includes two main passages:
a first passage 6 extending substantially in a first direction A, and
a second passage 7 extending substantially in a second direction B inclined or perpendicular with respect to the first direction A.

In the present case, the first direction A and the second direction B are perpendicular to one another.

The housing 4 is arranged such that the first direction A extends substantially horizontally and the second direction B extends substantially vertically (the concepts of “vertical”, “horizontal”, “high”, “low” etc. should be understood, for the present application, according to the position in service of the device 1, i.e. when the housing 4 rests on the ground or a support via its support means 5).

In the present case, the first passage 6 extends coaxially to the first direction A and the second passage 7 extends coaxially to the second direction B.

The first passage 6 opens out, at a first end, to the outside of the device 1 in order to form the inlet of the device 1 and, at its second end, into the second passage 7. The second passage 7 opens out, at a first end, into the first passage 6 and, at a second end, into the observation module 3.

Optionally, the second end of the second passage 7 is shaped like a truncated cone 8, narrowing towards the observation module 3.

This makes it possible to limit a deposit of particles on the walls of the observation module 3 or of the preparation module 2 during passage of the air stream between the two modules.

However, the second end of the second passage 7 can be shaped differently, according to an observation volume and/or flow rate of the target air stream in the observation module 3.

However, it is preferable that the second end of the second passage 7 is shaped such that its cross-section (along a sectional plane normal to the second direction B) gradually reduces in the direction towards the observation module 3. This will again be able to limit the risk of deposits.

The preparation module 2 further comprises means for magnifying particles (and therefore potentially particles of the test aerosol) contained in the air stream. The aim of the magnification is to make the test aerosol particles detectable by the observation module 3.

The magnification means are designed to condense, onto the particles contained in the air stream, the vapour of at least one solvent, in order to obtain droplets.

For this purpose, the magnification means comprise means for producing the vapour of at least one solvent. Typically, said means comprise a reservoir 9 containing a given solvent (liquid or solid). This reservoir 9 is arranged, for example, under the housing 4 between the support means 5 of the housing. Alternatively, the reservoir 9 is arranged directly inside the housing 4. In both cases, the reservoir 9 is preferably arranged under the first passage 6. In addition, at least one segment of the first passage 6 is open above the reservoir 9 in order that the reservoir 9 and the first passage 6 can communicate in this segment.

The means for producing vapour also comprise a heating block (not referenced here) associated with the reservoir 9; such that the heating block heats the solvent or solvents contained in the reservoir 9, which then evaporate in order to come into contact with the particles present in the air stream flowing in the first passage directly above the reservoir 9. In this way, the particles are impregnated with vapour of the solvent or solvents.

For example, a single solvent is used.

For example, the solvent is glycerol.

For example the heating block heats the solvent to a temperature between 70 and 90 degrees Celsius and preferably to a temperature substantially equal to 80 degrees Celsius.

Furthermore, the magnification means comprise means for cooling the solvent in order to form the droplets as previously indicated.

Said means are preferably situated at the second passage 7. For example, said means comprise a cooling column 10 forming or surrounding the second passage 7. For example, the cooling column 10 includes one or more Peltier-effect plates.

For example, the cooling means cool the inside of the second passage 7 to a temperature of between 0 and 20 degrees Celsius and preferably to a temperature substantially equal to 10 degrees Celsius.

Consequently, the particles, which have entered into the device at the inlet of the preparation module 2, leave said module in order to enter into the observation module 3 in the form of droplets.

Thus, the magnification means are designed to obtain monodispersed droplets. Here, the term “monodispersed” means that the droplets have substantially the same size.

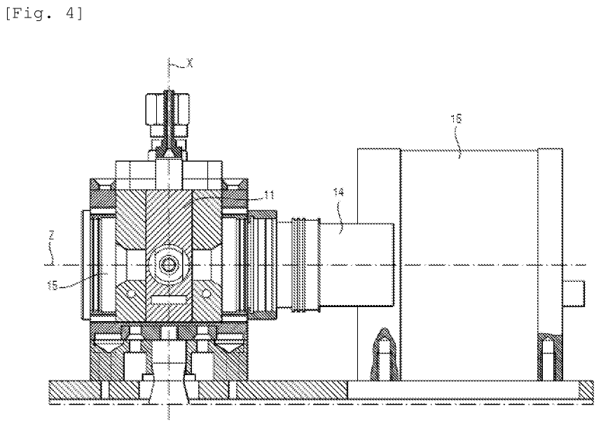

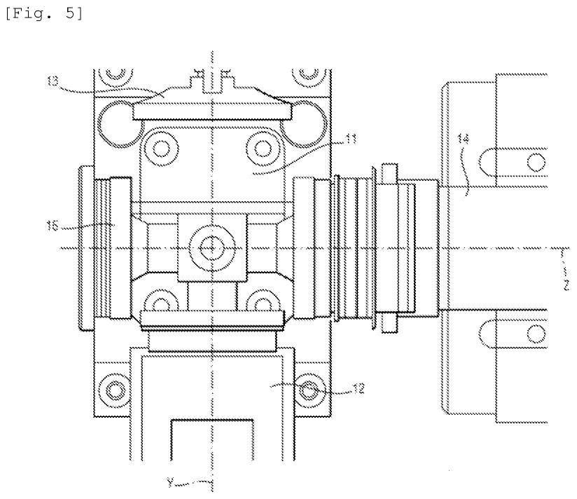

With reference to FIGS. 2, 4 and 5, the observation module 3 comprises a chamber 11. Therefore, here, the chamber 11 rests on an upper surface of the housing 4 of the preparation module 2 in order that the observation module 3 is located on the preparation module 2.

The second passage 7 of the preparation module 2 is connected to the lower part of said chamber 11.

Preferably, the device 1 includes sealing means at the connection between the preparation module 2 and the observation module. The sealing means comprise, for example, a seal arranged at the junction between the two modules.

The chamber 11 is then arranged so that the stream loaded with droplets passes through the chamber 11 in a first direction X. In the present case, the chamber 11 is designed such that the first direction X extends substantially vertically.

Consequently, the second passage 7 extends coaxially to said first direction X.

It should also be noted that the stream loaded with droplets passes through the chamber 11 passes through the chamber 11 in a substantially rectilinear manner.

This enables a stream with laminar flow. This limits the risk of dispersion of the droplets in the chamber 11. This limits the risk of depositing droplets in the chamber.

In the same way, the fact that the second passage 7 extends in the alignment of the chamber 11 can promote this laminar flow.

In addition, the fact that the second end of the second passage 7 gradually reduces towards the observation module 3, also promotes this laminar flow.

The device 1 thus described, can largely limit the risk of dispersion of the droplets in the chamber 11, which limits the risk of deposition and improves the quality of measurements carried out by the observation module 3.

The chamber 11 is, for example, designed overall as a prism, the two bases of which are defined by a four-sided polygon. Therefore, overall, the chamber 11 as a parallelepiped or cubic shape.

The observation module 3 also comprises a light source 12 able to generate a light beam directed, in service, towards the stream of droplets.

Said light source 12 is, in reality, chosen in order to allow at least one of the particles of the aerosol present in the droplets to be excited. Thus, preferably, the light source 12 is chosen such that the emission wavelength of the light source 12 (or its emission wavelength band) is offset from the excitation wavelength of the particles of the aerosol that it is desired to detect (or its excitation wavelength band). It should be noted that the solvent vapour can modify this excitation wavelength (or this excitation wavelength band) and that it is therefore preferable to take it into account in order to characterise the emission wavelength of the light source 12 (or its emission wavelength band).

Hence, the excitation wavelength band and the emission wavelength band do not overlap.

The risk of a disturbance in the excitation of the particles is therefore limited.

In the example indicated, the light source 12 is chosen to enable at least the fluorochrome particles (which are very characteristic of the test aerosol) to be excited.

Said light source 12 includes, for example, a laser for generating said light beam.

Preferably, the laser is a fibre laser.

Preferably, the laser is a square-optical-fibre laser

Advantageously, such a laser makes it possible to obtain a light beam with a luminous intensity that is very homogeneous (over time and over the entire emission wavelength band of the laser).

Consequently, it is possible to very homogeneously excite the various particles of the test aerosol present in the different droplets.

Preferably, the laser is a blue laser.

The laser has, for example, an emission wavelength of between 400 and 500 nanometres and, for example, between 450 and 480 nanometres and, for example, an emission wavelength of approximately 478 nanometres.

The light source 12 is arranged in the observation module 3 such that the general direction of the light beam extends in a second direction Y (the general direction of the light beam being the direction parallel to which the majority of the rays forming said beam extend) which is inclined or orthogonal with respect to the first direction X. In the present case, the second direction Y and the first X are orthogonal to one another. Thus, the light beam extends generally horizontally.

Preferably, the observation module 3 includes an optical trap 13 associated with the light source 12 in order to block the light beam once it has passed through the stream of droplets, in order to prevent the light beam from propagating multiple times in the chamber 11.

For example, the optical trap 13 absorbs said light beam. The optical trap 13 is, for example, a beam trap.

In the present case, the light source 12 and the optical trap 13 are arranged on either side of the chamber 11. For example the light source 12 is arranged on a first lateral side of the chamber 11 and the optical trap 13 is arranged on a second lateral side of the chamber 11, opposite the first.

The observation module 3 further includes an optical cell 14 for collecting a light emission resulting from the excitation of at least one particle of the test aerosol by the light source 12.

Here, the optical cell 14 is a camera. The camera is preferably a scientific camera [such as a scientific Complementary Metal-Oxide-Semiconductor (sCMOS) camera and/or a back-illuminated camera.

In the illustrated example, according to the fluorescence principle, the test aerosol particles that are present in the droplets and excited, will re-emit a light which can be collected by the optical cell 14 and enables the detection of the particles of the test aerosol. Hence, here, the light emission of the particles of the aerosol can be called “fluorescent light emission”

The camera is preferably provided with a filter for collecting the majority of the light emissions resulting from the excitation of the particles of the targeted aerosol (in this case, the test aerosol).

Here, the filter is therefore chosen on the basis of the wavelength (or wavelength band) of light emitted (here, fluorescent light) from the particles of the targeted aerosol (it being understood that, as previously indicated, if the solvent vapour changes the emission wavelength (or wavelength band) of the aerosol particles, it is preferable for this to be taken into account in order to define the filter used).

In the present case, the filter is therefore a filter enabling the camera to work in a wavelength band centred around a value of between 480 and 580 nanometres, and preferably centred around a value of between 500 and 540 nanometres and preferably centred around 520 nanometres. The filter is, for example, a 520-nanometre filter.

In the present case, the filter is preferably chosen in order that the camera works in a wavelength band offset with respect to the one or more characteristic absorption wavelengths of the particles of the targeted aerosol (and here particles of the targeted fluorochrome). There is thus no overlap between the reception wavelength band of the camera and that of absorption wavelengths characteristic of the particles of the targeted aerosol.

The optical sensor (which is here the camera) is arranged in the observation module 3 such that its optical axis (i.e. its axis of observation is again the axis corresponding to the direction of propagation of the captured light) generally extends in a third direction Z which is inclined or orthogonal with respect to the first direction X. In the present case, the third direction Z and the second direction X are mutually orthogonal. The optical axis of the camera thus extends substantially horizontally.

Consequently, the optical axis of the camera here extends orthogonally to the general direction of the light source 12.

For example the camera is arranged on a third lateral side of the chamber 11 being situated between the first side associated with the light source 12 and the second side associated with the optical trap 13.

The observation module 3 preferably includes a second optical trap 15 associated with the camera in order to limit the propagation of light emissions—(here fluorescent emissions) in a direction other than that of the camera.

The second optical trap 15 absorbs, for example, said light beam. The second optical trap 15 is for example a beam trap.

In the present case, the camera and the second optical trap 15 are arranged on either side of the chamber 11. For example, the camera is arranged on the third lateral side of the chamber 11 and the second optical trap 15 is arranged on the fourth lateral side of the chamber 11, opposite the third side.

It is also understood that the chamber 11 is cleverly configured in the form of a prism with four-sided bases with two successive sides associated respectively with the light source 12 and with the camera, the other two sides being provided with optical traps 13 and 15.

Furthermore, the stream of droplets opens out at the base of the chamber 11 between these four sides in order to leave the observation module 3 via its ceiling.

Consequently the entire stream of droplets passes through the light beam which makes it possible to analyse said stream very well.

Once again, the laminar flow of the stream through the chamber 11 can limit the risk of dispersion of droplets in the chamber and a deposit of the said droplets on the walls of the chamber.

Preferably, the device 1 includes means 16 for processing information generated by the optical cell 14. The device 1 thus proves to be more autonomous.

These processing means 16 form, for example, part of the observation module 3 or belong to a third module of the device 1. For this purpose the processing means 16 includes at least one computing member, such as a microcomputer, a calculator, etc.

The computing member preferably controls the remainder of the device 1, for example the flow rate regulator or even the light source 12 and the optical cell 14.

Here, the processing means 16 are configured in order to characterise the particles of the test aerosol and to carry out a simultaneous counting of the particles of the test aerosol. For this purpose, the processing means 16 are provided in order to determine a particle size distribution of the particles and/or the concentration (in particles or mass) of the particles of the test aerosol and to do so according to the luminous intensity of the light emissions recorded by the camera. It should be understood that, in reality, these light emissions appear in the form of pulse peaks which it is therefore possible to analyse by counting them (with one peak corresponding to one particle), but also by linking the light intensity of one of the peaks to the size (i.e. the diameter) of the particle having induced this peak (for example, using the theories of Fraunhofer or Mie).

For example, the processing means 16:
optionally process at least one image supplied by the camera in order to facilitate the reading of the one or more light intensity peaks present in said image,
calculate the number of peaks and deduce the number concentration of particles in the air stream.

For example, the processing means 16:
optionally process at least one image supplied by the camera in order to facilitate the reading of the one or more light intensity peaks present in said image,
estimate the light intensity of said one or more peaks,
calculate the mass concentration as a function of the estimation of the luminous intensity of the one or more peaks.

Of course, in both cases, the more the images are analysed, the more precise the calculation of the number concentration of particles or the mass concentration.

Advantageously, since the images are taken continuously, it is possible to rapidly enhance the precision of the number concentration of particles or mass concentration.

For the last step of the mass concentration calculation, in order to link the mass concentration of particles of a given fluorochrome (which here is sodium fluorescein) with the intensity of the emitted fluorescence I_{fluorescence}, the processing means 16 can, for example, use the following formula:

$${I}_{fluorescence} = k \cdot Φ \cdot {I}_{o} \cdot ( 1 - {e}^{- ε \underline{1} C} )$$

with:
k an optical constant
Φ a quantum yield of fluorescence at the excitation wavelength (which is here known and predetermined) i.e. the efficiency of emission of a given fluorochrome.

Iₒ a luminous intensity of an incident radiation at the excitation wavelength considered (the incident radiation being dependent on the power of the laser and of the sensitivity of the camera),
ε a molar absorption coefficient of the given fluorochrome at the emission wavelength considered.
l a value of the optical path travelled by the incident radiation in order to reach the optical sensor (in the present case, substantially equal to the distance separating the camera from the first direction X).

The device 1 can thus obtain a number concentration of particles and/or a mass concentration of particles of the test aerosol which is/are advantageously independent of the diameter of the test aerosol particles (due to the fact that the droplets are all substantially the same size).

In addition, the device 1 thus makes it possible to obtain a mass concentration of the test aerosol particles which is/are advantageously independent of their number (the device 1 carrying out a simultaneous counting of the droplets) even if, obviously, the more the number of particles taken into account increases, the more precise the mass concentration calculation is.

With regard to another aspect, the processing means 16 are provided in order to determine a particle size distribution of the particles of the test aerosol as a function of the luminous intensity of the light emissions recorded by the camera.

For example, the processing means 16:
process at least one image supplied by the camera in order to facilitate the reading of the one or more light intensity peaks present in said images,
identify the luminous intensity peaks,
estimate for each peak, the size of the particles (for example by using the Fraunhofer or Mie theories) having induced this peak.

Of course, in both cases, the more the images are analysed, the more the particle size distribution is enhanced.

Advantageously, since the images are taken continuously, it is possible to rapidly enhance the particle size distribution.

The device 1 thus enables simultaneous measurement of a plurality of test aerosol particles (since several peaks can be present on a same image).

Furthermore, the device 1 preferably includes a communication interface (not shown here) for communicating with the outside of the device 1 in order to transmit the information generated by the optical cell 14 and/or the processing means 16. The communication interface is, for example, a wireless communication interface (by Wifi, by Bluetooth, etc.) and/or a wired connection interface (USB port, HDMI, etc.).

The device 1 also includes power supply means (such as a battery) and/or means for connection to a mains socket (not referenced here).

In service, the stream sampled in the ventilation network mixes with the solvent vapour. On arriving in the cooling column 10, the solvent vapour condenses on each particle of the stream sampled (in particular on each test aerosol particle) thus forming a multitude of droplets of predetermined and substantially identical diameter for all the droplets. For example the droplets have a diameter of order approximately two micrometres.

The stream loaded with droplets then leaves the preparation module 2 in order to enter into the observation module 3.

Said stream passes, in its entirety, through the light beam which will then excites at least the droplets including a test aerosol particle.

The light emissions which occur are then captured continuously by the camera with a simultaneous counting of the various test aerosol particles excited by the light beam. The data collected by the camera can then be processed by the processing means 16.

Then the stream loaded with droplets leaves the chamber 11, sucked by the pump, and returns into the ventilation network.

The device 1 thus described can work in real time and continuously.

The device 1 can not only detect the presence of at least one particle of an aerosol in a stream, but is also able to characterise the particles and carry out a simultaneous counting (more specifically, the device 1 does not work here droplet by droplet, but in a continuous manner, thus making it possible to work simultaneously on various droplets passing through the light beam).

The device 1 advantageously enables a deposit of droplets in the observation module 3, which could damage it in the long term, to be limited as much as possible. For this purpose, the device 1 is designed in order to promote a laminar flow of the stream loaded with droplets in the device 1.

In addition, the device 1 has a limited mass and volume, which makes it easy to move from one place to another. In particular, the device 1 is portable and can be moved by a single person. The inventors have thus been able to develop a prototype weighing less than 5 kilograms.

Of course, the invention is not limited to the described embodiment and variations can be made without going beyond the scope of the invention as defined by the claims.

Hence, although the stream to be analysed here is an air stream, the invention could be used for other gas streams.

Although here the invention is arranged in a nuclear power plant, the invention could be arranged in any other place, whether or not linked to nuclear energy. For example the invention could be arranged in a hospital for connection with a sterile room (chamber, operating room, etc.) or even in a business, for connection with room of the clean-room type. Hence, the invention could be associated with the hospital environment, the agri-food environment, the industrial environment, environmental environment, in a field, in a hospital, on an industrial site, etc. Hence, the invention could be associated with a nuclear environment or with a non-nuclear environment. The invention could be associated with an open environment or with a closed environment.

In general, the invention could be associated with any environment where it is desired to know the existence of at least one (potentially polluting) aerosol particle.

Advantageously, the invention can be easily moved from one place to another and this means that it can be used in different applications.

Thus, wherever it is arranged, the device can be used to ensure the quality of a filtration system in general, with one or more filters (HEPA or not), or quite simply the quality of the air (or of another gas) of a given location (closed or not).

Thus, although it is sought here to detect a test aerosol, it is possible to seek to identify an aerosol naturally present in the studied environment. The light source will thus be chosen to enable the excitation of a specific targeted aerosol and the sensor for detecting the resulting light emission, as indicated above.

Of course, it is also possible to choose the light source in order to enable the excitation of several types of particles of a targeted aerosol.

The specific aerosol targeted could be sodium fluorescein or another aerosol, a rhodamine-based aerosol, an allophycocyanin-based aerosol, a chlorophyll-based aerosol etc. The targeted could be solid or liquid.

Consequently, the optical sensor will be able to detect particular light emissions which will not necessarily be fluorescence as has been described above.

Of course the solvent contained in the reservoir of magnification means will then be chosen according to the targeted aerosol, and will not therefore necessarily be glycerol. It is also possible to simply have water as the solvent (whether or not the targeted aerosol is sodium fluorescein).

The device will be able to include storage means in order to record information generated by the optical cell and/or the processing means (local memory, micro-SD card, etc.).

The light source could be different from that which was indicated. However, it will be sought to have a light source having a light beam with the most homogeneous possible luminous intensity. For example, it will be possible to use a non-fibre laser and to associate it with filtering means in order to select an emission wavelength band which is of substantially the same luminous intensity.

Although, here, the entire stream passes through the light beam of the light source, only a fraction of said beam could pass through said beam (it being understood that this portion will be determinable from the positioning of the light source in said chamber and from the path effected by the stream in the chamber).

Although, here, the optical sensor is a camera, the optical sensor could be of any other type, such as a couple charge device (CCD) sensor. The sensor could thus be a spherical sensor, a round sensor, a linear sensor etc. The optical cell could thus include a plurality of optical sensors and, for example, a succession of optical sensors juxtaposed in a rectilinear direction or even a succession of optical sensors arranged circumferentially in the chamber.

1. An observation module for a device for detecting the presence of at least one particle of an aerosol in a stream, the module comprising at least:
a chamber through which flows, in service, the stream;
a light source able to generate a light beam passing through, in service, the stream, the light source being a square-fibre laser; and
an optical cell comprising at least one optical sensor for collecting a light emission resulting from an excitation of at least the particle of the aerosol by the light source.

2. The observation module according to claim 1, designed such that, in service, the stream passes through the chamber substantially vertically.

3. The observation module according to claim 1, wherein the light source is arranged such that a general direction of the light beam extends in a direction which is substantially horizontal.

4. The observation module according to claim 1, wherein the optical sensor is arranged such that an optical axis of the optical sensor extends in a direction which is substantially horizontal.

5. The observation module according to claim 1, wherein the optical sensor and the light source are arranged such that, respectively, an optical axis of the optical sensor and a general direction of the light beam generated by the light source extend substantially orthogonally to one another.

6. The observation module according to claim 1, comprising at least one optical trap associated with the light source and/or the optical sensor.

7. The observation module according to claim 1, comprising means a processor for processing information generated by the optical cell.

8. The observation module according to claim 7, wherein the processor is configured to characterise the particles of the test aerosol and/or to carry out a simultaneous counting of the particles of the test aerosol.

9. A device for detecting the presence of at least one particle of an aerosol in a stream, the device comprising an observation module according to claim 1 and a preparation module connected to said observation module.

10. An application of the observation module according to claim 1, for monitoring a ventilation network of a nuclear industry site.

11. An application of the observation module according to claim 1, for detecting at least sodium fluorescein.
